(19) United States
(12) Patent Application Publication
(10) Pub. No.: US 2016/0306160 A1
(43) Pub. Date: Oct. 20, 2016

(54) Exploration Device

(71) Applicant: Lucas Roy Adams, Canby, OR (US)

(72) Inventor: Lucas Roy Adams, Canby, OR (US)

(21) Appl. No.: 15/134,057

(22) Filed: Apr. 20, 2016

Related U.S. Application Data
(60) Provisional application No. 62/150,135, filed on Apr. 20, 2015.

(51) Int. Cl. G02B 21/36; H04N 13/02; G01N 21/05; H04B 10/116; G02B 21/26

(52) U.S. Cl. CPC G02B 21/367; H04B 10/116; G02B 21/26; G02B 21/362; G01N 21/05; H04N 13/0203; G01N 2021/0378

(57) ABSTRACT

Disclosed may be an exploration device for facilitating exploration of a specimen and/or an environment. The exploration device may include an enclosure, transparent to visible light, configured to contain a specimen. Additionally, the exploration device may include a plurality of cameras disposed around the enclosure. Further, each camera may be orientable towards the enclosure. Furthermore, images captured by the plurality of cameras may be processable by a computer to generate a three dimensional (3D) digital representation of the specimen and/or the environment. Additionally, the exploration device may include a support structure configured to support each of the enclosure, the plurality of cameras, a communication interface and a battery.

### FIELD OF INVENTION

The present disclosure generally relates to exploration devices configured to facilitate exploration of a spatial region comprising one or more objects. More specifically, the present disclosure relates to an exploration device configured to create 3D digital representations of a specimen and/or an environment surrounding the exploration device.

### BACKGROUND OF THE INVENTION

There are several situations where visual study of a specimen and/or an environment may be needed. For instance, scientists often study visual characteristic of a fluid specimen containing one or more suspended particles and/or organisms. As another instance, a visual survey of an environment may also be needed to study characteristics of the environment.

However, visual study based only on the naked eye may be deficient. Further, the use of existing image capturing devices may not provide a holistic view of a specimen and/or an environment. For instance, existing microscopes provided a limited field of view over a sample. Accordingly, several user operations, such as manipulating the sample, may be needed in order obtain a more comprehensive views of the sample. Similarly, in case of studying environments, existing camera setups that provide wide angle views are limited in terms of their flexibility, for example, to study environments at different scales.

Moreover, the subject of study may not be physically accessible to users for various reasons. For instance, there are many users who may be handicapped or disabled who wish to explore remote outdoor environments. Similarly, scientists and researchers who wish to study and analyze such environments may not be capable of physically traveling to such locations.

Additionally, for convenience, an object of study such as a specimen and/or an environment may be electronically represented such as, for example, in the form of a digital representation. However, existing digital representations are not flexible and/or user-friendly enough to provide an intuitive interface for navigating through the digital representations. For example, navigation may be limited to performing operations such as zooming and panning in two dimensions.

Accordingly, there is a need for exploration devices configured to facilitate study of spatial regions such as, for example, a specimen and/or an environment. Further, there is also a need for providing improved digital representations of information captured by such exploration devices.

### SUMMARY OF THE INVENTION

Disclosed may be an exploration device for facilitating exploration of a spatial region including one or more objects. Additionally, in some embodiments, the exploration device may be configured to float on water. Further, in some embodiments, the exploration device may be configured to be water resistant.

The exploration device may include an enclosure configured to contain a specimen. Further, the enclosure may be transparent to visible light. Additionally, the exploration device may include a plurality of cameras disposed around the enclosure. Further, each camera may be orientable towards the enclosure.

Further, in some embodiments, each camera of the plurality of cameras may include one or more microscope lenses. Furthermore, in some embodiments, each camera of the plurality of cameras may include a plurality of microscope lenses corresponding to a plurality of optical magnification. Additionally, each camera further may include a lens actuator configured to select a microscope lens of the plurality of microscope lenses. Accordingly, selection of the microscope lens results in capturing images at an optical magnification of the microscope lens.

Additionally, in some embodiments, the exploration device may include a plurality of gyroscopes coupled to the plurality of cameras.

Additionally, in some embodiments, the exploration device may include one or more light sources configured to illuminate the specimen. Further, the support structure may be further configured to support the one or more light sources. Accordingly, the battery may be further configured to provide electrical power to the one or more light sources.

Further, in some embodiments, the exploration device may include a plurality of actuators corresponding to the plurality of cameras. Moreover, an actuator corresponding to a camera may be configured to change at least one of an orientation, a position and a focal region of the camera. Additionally, the support structure may be further configured to support the plurality of actuators.

Further, the plurality of actuators may be configured to orient the plurality of cameras towards a surrounding of the exploration device. Furthermore, the surrounding may include the spatial region. Furthermore, the plurality of cameras may include a first set of cameras oriented towards the enclosure and a second set of cameras oriented towards the surrounding.

Furthermore, images captured by the plurality of cameras may be processable by a computer to generate a three dimensional (3D) digital representation of the spatial region. Further, the spatial region may include the specimen when the plurality of cameras may be oriented towards the enclosure.

Additionally, the exploration device may include a communication interface coupled to the plurality of cameras. Further, the communication interface may be configured to communicate data based on images captured by the plurality of cameras.

Furthermore, the exploration device may include a battery configured to provide electrical power to one or more of the plurality of cameras and the communication interface.

Additionally, the exploration device may include a support structure configured to support each of the enclosure, the plurality of cameras, the communication interface and the battery. Further, the support structure may be configured to be expandable and collapsible. Accordingly, in some embodiments, the support structure may be based on one or more of a Hoberman's sphere and a Fuller's Geodesic Sphere.

Further, the support structure may include a plurality of spherical structures concentric to each other. Furthermore, each spherical structure may be configured to be expandable and collapsible.

Additionally, in some embodiments, the exploration device may include a plurality of ball-and-socket joints coupled to the plurality of cameras. Further, a ball-and-socket joint coupled to a camera may be configured to maintain the camera in one of a plurality of orientations. Furthermore, an actuator corresponding to the camera may be coupled to the ball-and-socket joint.

Additionally, the support structure may be further configured to support the plurality of ball-and-socket-joints.

Further, in some embodiments, the exploration device may include one or more ducts fluidly connected to the enclosure. Further, the one or more ducts may include one or more openings to receive fluid and one or more openings to expel fluid.

Additionally, in some embodiments, the exploration device may include one or more sensors coupled to each of the plurality of cameras. Further, the communication interface may be further configured to communicate sensor data generated by the one or more sensors.

Additionally, in some embodiments, the exploration device may include a plurality of solar panels separably disposed over the support structure. Further, a solar panel may be configured to charge the battery based on light energy received on the solar panel.

Additionally, in some embodiments, the exploration device may include one or more propulsion systems connected to the support structure. Further, the one or more propulsion systems may be configured to propel the exploration device in one or more of land, water, air and outer space.

Additionally, in some embodiments, the exploration device may be configured to be remotely controlled. Further, the communication interface may be configured to wirelessly receive a control signal from a remote control device. Furthermore, the actuator may be configured to change one or more of an orientation, a position and a focal region of the camera based on the control signal.

Additionally, in some embodiments, the exploration device may be configured to be remotely controlled by a mobile phone connected to a retrofit dock.

Additionally, in some embodiments, the exploration device may be configured to enable the one or more propulsion systems to be remotely controlled. Further, the communication interface may be configured to wirelessly receive a control signal from a remote control device. Accordingly, operation of the one or more propulsion systems may be based on the control signal.

Further, the one or more propulsion systems may include a plurality of arms configured to enable the exploration device to climb a vertical surface. Furthermore, an arm of the plurality of the arms may be further configured to direct an object towards an opening of one or more ducts included in the exploration device. Furthermore, the one or more ducts may be fluidly connected to the enclosure.

Additionally, in some embodiments, the exploration device of may include a protector enclosing the exploration device. Further, the protector may be configured to prevent physical contact between external objects and the support structure. Furthermore, in some embodiments, the protector may include at least one of a plastic bubble and a micro net.

According to some embodiments, an exploration device for facilitating exploration of a specimen is provided herein. The exploration device may include an enclosure configured to contain the specimen. Further, the enclosure may be transparent to visible light. Additionally, the exploration device may include a plurality of cameras disposed around the enclosure. Further, each camera may be oriented towards the enclosure. Furthermore, images captured by the plurality of cameras may be processable by a computer to generate a three dimensional (3D) digital representation of the specimen. Additionally, the exploration device may include a communication interface coupled to the plurality of cameras. Further, the communication interface may be configured to communicate data based on images captured by the plurality of cameras. Additionally, the exploration device may include a battery configured to provide electrical power to at least one of the plurality of cameras and the communication interface. Further, the exploration device may include a support structure configured to support each of the enclosure, the plurality of cameras, the communication interface and the battery.

### BRIEF DESCRIPTION OF THE DRAWINGS

FIG. 1 is an illustration of an exploration device configured to facilitate exploration of a specimen and/or an environment in accordance with some embodiments.

FIG. 2 is a flowchart depicting a method of operating the exploration device configured to facilitate exploration of a specimen and/or an environment in accordance with some embodiments.

FIG. 3 is a flowchart depicting a method of collecting data using the exploration device configured to facilitate exploration of a specimen and/or an environment in accordance with some embodiments.

FIG. 4 is a depiction of the traversal methods that may be performed by the exploration device configured to facilitate exploration of a specimen and/or an environment in accordance with some embodiments.

FIG. 5 illustrates rolling movement control system attachment cage for the entire internal entity used for attaching internal cameras and mechanisms as well as the internal placement for the magnetic controls for the outer bubble shell dual hemisphere droids.

FIG. 6 illustrates an internal rolling cage and external dual hemisphere droids with the bubble shell removed so that the entire aligned magnetic rolling movement control system is visible.

FIG. 7 illustrates an outer bubble shell with the dual hemisphere magnetic motion control system droids for controlling the entire spherical motion abilities of the internal entity.

FIG. 8 is an illustration of a spherical matrix of line of site capabilities of a plurality of cameras included in an exploration device configured to facilitate exploration of a specimen and/or an environment in accordance with some embodiments.

### DETAIL DESCRIPTIONS OF THE INVENTION

All illustrations of the drawings are for the purpose of describing selected versions of the present invention and are not intended to limit the scope of the present invention.

Overview

This overview is provided to introduce a selection of concepts in a simplified form that are further described below. The overview is not intended to identify key features or essential features of the claimed subject matter. Further, the overview is not intended to be used to limit the claimed subject matter's scope.

The present disclosure relates generally to an exploration device that may, in some embodiments, be a versatile, semi-autonomous, long-distance traveling drone configured to gather environmental data. The exploration device may be capable of being used by handicapped or non-handicapped, and can be used to observe a 3-D environment of a sampled space. The sampled space can be computer-analyzed and processed to be re-created for analysis. One objective of the disclosed exploration device may be to allow users to gather environmental data, analyze remote environments, as well as enjoy viewing remote locations.

Accordingly, in some embodiments, the exploration device may be configured to facilitate exploration of, for example, a specimen and/or an environment surrounding the exploration device. For instance, the exploration device may be configured to be a remote-controllable, agile/maneuverable, long-distance, solar-powered drone used for gathering environmental data and remote observation. Further, the exploration device may be capable of traversing a variety of terrain and vectors, including planetary surface, aerial, aquatic, etc. Furthermore, the exploration device may be configured to display the gathered data via a virtual reality system.

Further, in some embodiments, the exploration device may be similar in shape and construct to a living cell, and may be capable of self-travel to any surface point on the planet with recurring available sunlight. Additionally, in some instances, there may be maintenance stations manned by humans educated in the maintenance of the exploration device, all over the planet.

As mentioned, the exploration device may be configured to self-travel and continue to do so until its resources are depleted. Further, the exploration device may be configured to go out into the world to gather data, while following preprogrammed paths or following user manual input. Additionally, the exploration device may be configured to replenish its energy reserves through solar power, possibly while hanging on a tree branch or floating near the surface of the ocean, or flying above the clouds to absorb sunlight energy. Furthermore, the exploration device may be configured to continue exploring using a highly capable system of GPS triangulation in combination with user-inputted decisions based on a transmitted, hyper-realistic view of what is happening in the vicinity of the exploration device.

In some embodiments, if a solar-powered system can absorb energy quickly enough to maintain aerial inclusion without losing considerable altitude, the exploration device may be able to travel indefinitely.

As a result of using the exploration device, in terms of remote observation, a user can virtually travel to the ocean reefs surrounding Fiji until the battery dies and sets up for recharge. Then the user could connect to the exploration device that may have been charging while snuggling in one of the giant mango trees of South America.

Similarly, the user can use the exploration device until the battery dies and sets up for recharge, then connect to the exploration device as it may be hanging from a branch in the forests that surround Mt. Fuji in Japan. The user can then travel straight out to the ocean until the battery dies. Accordingly, the exploration device may drop in the water and float until it is recharged enough by the sunlight to take off and continue traveling, etc.

Further, the exploration device may have numerous remote travel and virtual reality applications. A user could remotely ride amongst a skate park as though they were a skateboard, and take off while flying through the air after launching from a ramp. The exploration device could be used underground in areas like caves and then retrieve emplaced radio systems. Further, the exploration device could even bring its own set of placeable and retrievable radio transmitters, guaranteeing the ability to exfiltrate from locations that do not have the best of satellite signals, such as the aforementioned underground cave.

Disclosed is an exploration device 100 for facilitating exploration of a spatial region including one or more objects. For instance, the exploration device 100 may be configured for exploring a specimen such as, for example, but not limited to, a medium containing particles and/or organisms. The medium may be one of, but is not limited to, vacuum, air, fluid and solid. In another instance, the exploration device 100 may be configured for exploring an environment surrounding the exploration device 100. For example, the environment may be, for example, but is not limited to, a natural place such as a land, underground, water bodies, air and outer space.

Accordingly, the exploration device 100 may be configured to operate in one or more environments such as land, air, water and outer space. Accordingly, in some embodiments, the exploration device 100 may be configured to float on water. Further, in some embodiments, the exploration device 100 may be configured to be water resistant.

Further, in order to facilitate exploration, the exploration device 100 may include an enclosure 102 configured to contain a specimen. The enclosure 102 in general may be any physical arrangement that may support the specimen. In some instances, the enclosure 102 may be configured depending on characteristics of the specimen to be supported. For example, in case the specimen is of solid form, the enclosure 102 may be configured in the form of a cage or a mesh capable of securing the specimen. Similarly, in case the specimen is of liquid form, the enclosure 102 may be configured in the form of a closed structure capable of containing liquid without leaking out. For example, the enclosure 102 may be a spherical structure with a closable opening configured to receive fluid which may be held stably within the enclosure 102 till required.

Furthermore, the enclosure 102 may be transparent to visible light. Accordingly, the enclosure 102 may not present hindrance for a visual inspection of the specimen enclosed in the enclosure 102. For instance, the enclosure 102 may be constructed from acrylic to provide transparency. Alternatively, in some embodiments, the enclosure 102 may be configured to provide partial transparency of a predetermined degree. Further, the enclosure 102 may be constructed such that minimal or no optical distortions are introduced by the enclosure 102 in viewing the specimen enclosed within.

Additionally, the exploration device 100 may include a plurality of cameras 104 disposed around the enclosure 102. Further, each camera may be orientable towards the enclosure 102. Further, the spatial region may include the specimen when the plurality of cameras 104 are oriented towards the enclosure 102. For instance, in some embodiments, the plurality of cameras 104 may be equidistantly disposed around the enclosure in order to ensure that each part of the enclosure is within the field of view of one or more of the plurality of cameras 104. Accordingly, a wholistic view of the specimen may be provided by operating each of the plurality of cameras 104.

Further, in some embodiments, each camera of the plurality of cameras 104 may include one or more microscope lenses. Accordingly, a magnified view of portions of the specimen may be obtained. Furthermore, in some embodiments, each camera of the plurality of cameras 104 may include a plurality of microscope lenses corresponding to a plurality of optical magnification. Additionally, each camera further may include a lens actuator configured to select a microscope lens of the plurality of microscope lenses. Accordingly, selection of the microscope lens results in capturing images at an optical magnification of the microscope lens. In other words, the plurality of cameras may be able to capture images of the specimen at a range of magnifications.

Further, in some embodiments, the lens actuator may be configured to automatically select each of the plurality of microscope lens in a sequence. Accordingly, the specimen may be optically captured at multiple magnification levels. Alternatively, the lens actuator may be configured to select the microscope lens from the plurality of microscope lens based on a control command supplied by a user.

Additionally, in some embodiments, the exploration device 100 may include a plurality of gyroscopes coupled to the plurality of cameras 104. In some embodiments, a gyroscope coupled to a camera 104 may facilitate a stable orientation of the camera in relation to the enclosure 102. Accordingly, the camera 104 may be coupled to the spin axis of the gyroscope. Further, in some embodiments, the gyroscope may also facilitate determination of an orientation of the camera 104 in relation to other cameras of the plurality of cameras 104 and/or the enclosure 102.

Further, the plurality of actuators may be configured to orient the plurality of cameras 104 towards a surrounding of the exploration device 100. Furthermore, the surrounding may include the spatial region. Accordingly, the exploration device 100 may be configured to facilitate exploration of an environment external to the exploration device 100.

For instance, the plurality of cameras 104 when oriented towards the surrounding may capture images of one or more objects around the exploration device 100. Moreover, in some embodiments, the plurality of cameras 104 may be configured to capture the surrounding from a multitude of angles in order to obtain a wholistic view of the surrounding from vantage points associated with the exploration device 100.

As an example, the plurality of cameras 104 may be sufficiently large in number, for example, 100, in order provide 360 degree view of the surrounding from a vantage point associated with the exploration device 100, such as a center of the exploration device 100. Additionally, in some embodiments, each of the plurality of cameras 104 may include a telescopic lens configured to allow capturing of images of distant objects in the surrounding.

Further, a lens actuator included in a camera 104 may be configured to vary focus of the telescopic lens at a plurality of points. As a result, detailed images of objects located at different distances from the exploration device 100 may be obtained.

Furthermore, the plurality of cameras 104 may include a first set of cameras 104 oriented towards the enclosure 102 and a second set of cameras 104 oriented towards the surrounding. Accordingly, the exploration device 100 may, in some embodiments, be capable of capturing images of the specimen and that of the surrounding. Further, in some embodiments, each of the first set of cameras 104 and the second set of cameras 104 may be configured to be operated simultaneously.

Furthermore, images captured by the plurality of cameras 104 may be processable by a computer to generate a three dimensional (3D) digital representation of the spatial region. For instance, the computer may perform stitching of images obtained from each of the plurality of cameras 104 in order to provide a panoramic view, such as for example, 360 degrees view. Likewise, the computer may also perform stitching of images obtained from a camera 104 corresponding to each focal point and/or magnification level. Further, the computer may perform stitching of images in a temporal dimension as well. Furthermore, in order to create the 3D digital representation, the computer may utilize one or more image processing algorithms.

Additionally, the exploration device 100 may include a communication interface coupled to the plurality of cameras 104. The communication interface may include one or more of, but not limited, a wired interface such as USB, HDMI, Ethernet and so on and a wireless interface such as, for example, Wi-Fi, Bluetooth, cellular communication interface and so on. Further, the communication interface may be configured to communicate data based on images captured by the plurality of cameras 104. Accordingly, in some embodiments, the communication interface may transmit raw images captured by the plurality of cameras 104. Alternatively, in some embodiments, the exploration device 100 may include the computer onboard for processing the images. Accordingly, the communication interface may be configured to transmit the 3D digital representation which may be subsequently received by an external device such as a display device and visually rendered.

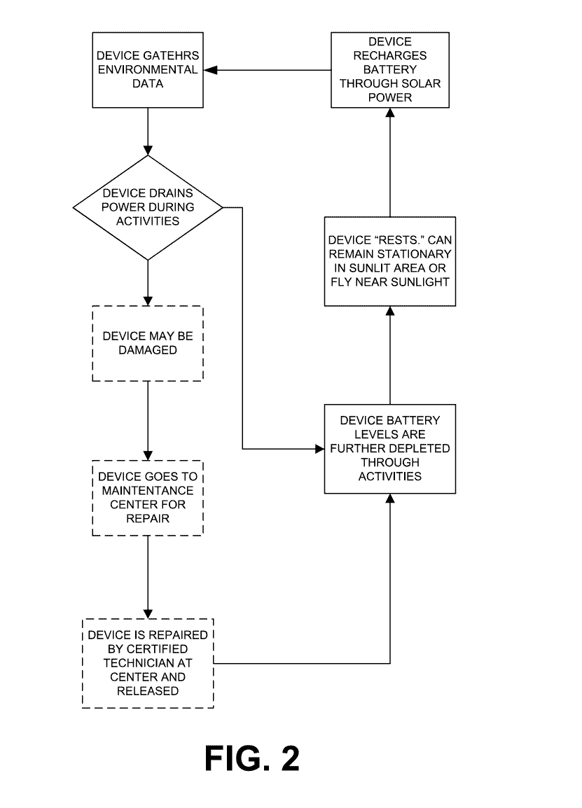

Furthermore, the exploration device 100 may include a battery configured to provide electrical power to one or more of the plurality of cameras 104 and the communication interface. Further, in some embodiments, the battery may be rechargeable. Accordingly, the battery may be discharged during operation of the exploration device 100 while being recharged during, for example, an idle period of exploration device 100 as exemplarily illustrated in FIG. 2. However, in some other embodiments, the battery may be charged during operation of the exploration device 100 as well.

Additionally, the exploration device 100 may include a support structure 106 configured to support each of the enclosure 102, the plurality of cameras 104, the communication interface and the battery. Further, the support structure 106 may be configured to be expandable and collapsible. Accordingly, in some embodiments, the support structure 106 may be based on one or more of a Hoberman's sphere and a Fuller's Geodesic Sphere.

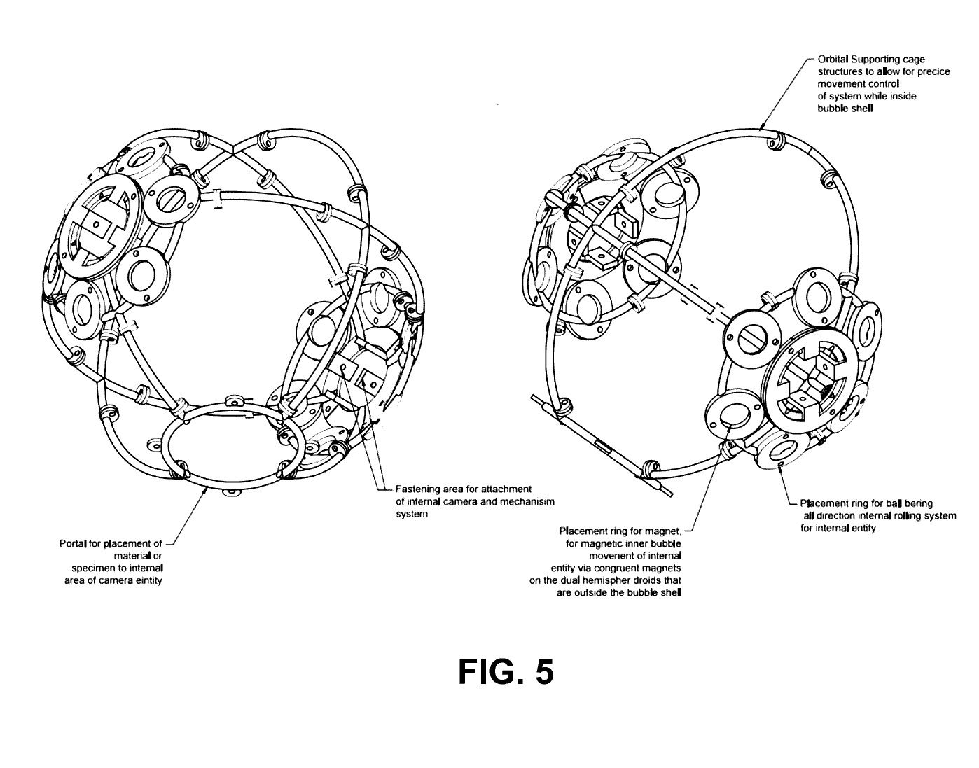

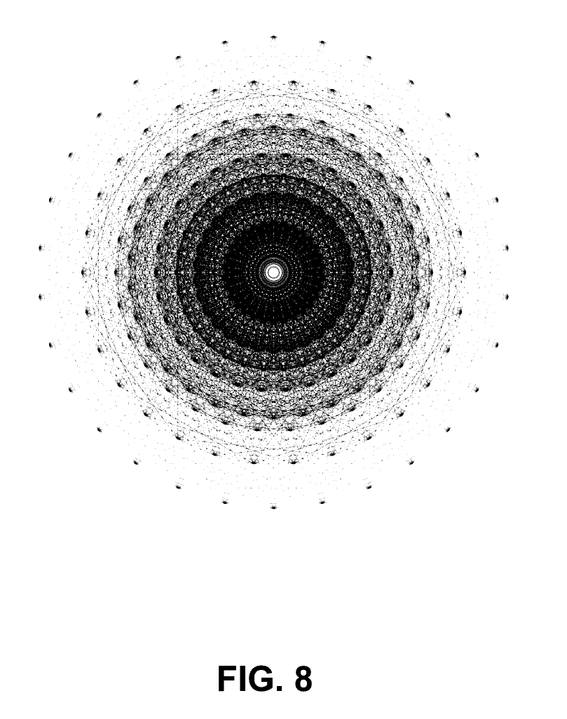

Further, the support structure 106 may include a plurality of spherical structures 106 concentric to each other as exemplarily illustrated in FIG. 8. Furthermore, each spherical structure 106 may be configured to be expandable and collapsible. Exemplary configurations of the support structure 106 are illustrated in FIG. 5 to FIG. 8.

Furthermore, FIG. 8 also illustrates a spherical matrix of line of site capabilities of the plurality of cameras corresponding to a digital tomographic recognition technique. Accordingly, the plurality of cameras 104 may be associated with a plurality of line of sights. Further, the images captured by the plurality of cameras 104 based on the plurality of line of sights may be processable by the computer using, for example, a digital tomographic reconstruction. Consequently, the 3D representation of the specimen and/or the environment may be generated.

Additionally, in some embodiments, the exploration device 100 may include a plurality of ball-and-socket joints coupled to the plurality of cameras 104. Further, a ball-and-socket joint coupled to a camera 104 may be configured to maintain the camera in one of a plurality of orientations. Furthermore, an actuator corresponding to the camera 104 may be coupled to the ball-and-socket joint. Additionally, the support structure 106 may be further configured to support the plurality of ball-and-socket-joints.

Additionally, in some embodiments, the exploration device 100 may include one or more light sources (not shown in figure) configured to illuminate the specimen. Additionally, in some embodiments, the one or more light sources may also be configured to illuminate the surrounding of the exploration device 100 for aiding exploration of the surrounding at night and/or in poor light conditions such as that in underground caves. Further, the support structure 106 may be configured to support the one or more light sources. Additionally, the battery may be further configured to provide electrical power to the one or more light sources.

Further, in some embodiments, the exploration device 100 may include a plurality of actuators (not shown in figure) corresponding to the plurality of cameras 104. Moreover, an actuator corresponding to a camera 104 may be configured to change one or more of an orientation, a position and a focal region of the camera. Additionally, the support structure 106 may be further configured to support the plurality of actuators.

Further, in some embodiments, the exploration device 100 may include one or more ducts (not shown in figure) fluidly connected to the enclosure 102. Further, the one or more ducts may include one or more openings to receive fluid and one or more openings to expel fluid.

Additionally, in some embodiments, the exploration device 100 may include one or more sensors (not shown in figure) coupled to each of the plurality of cameras 104. Further, the communication interface may be further configured to communicate sensor data generated by the one or more sensors.

Additionally, in some embodiments, the exploration device 100 may include a plurality of solar panels (not shown in figure) separably disposed over the support structure 106. Further, a solar panel may be configured to charge the battery based on light energy received on the solar panel.

Additionally, in some embodiments, the exploration device 100 may include one or more propulsion systems (not shown in figure) connected to the support structure 106. Further, the one or more propulsion systems may be configured to propel the exploration device 100 in one or more of land, water, air and outer space.

Additionally, in some embodiments, the exploration device 100 may be configured to be remotely controlled. Further, the communication interface may be configured to wirelessly receive a control signal from a remote control device. Furthermore, the actuator may be configured to change one or more of an orientation, a position and a focal region of the camera based on the control signal. Moreover, in some embodiments, the exploration device 100 may be configured to be remotely controlled by a mobile phone connected to a retrofit dock.

Additionally, in some embodiments, the exploration device 100 may be configured to enable the one or more propulsion systems to be remotely controlled. Further, the communication interface may be configured to wirelessly receive a control signal from a remote control device. Accordingly, operation of the one or more propulsion systems may be based on the control signal.

Further, the one or more propulsion systems may include a plurality of arms (not shown in figure) configured to enable the exploration device 100 to climb a vertical surface. Furthermore, an arm of the plurality of the arms may be further configured to direct an object towards an opening of one or more ducts included in the exploration device 100. Furthermore, the one or more ducts may be fluidly connected to the enclosure 102.

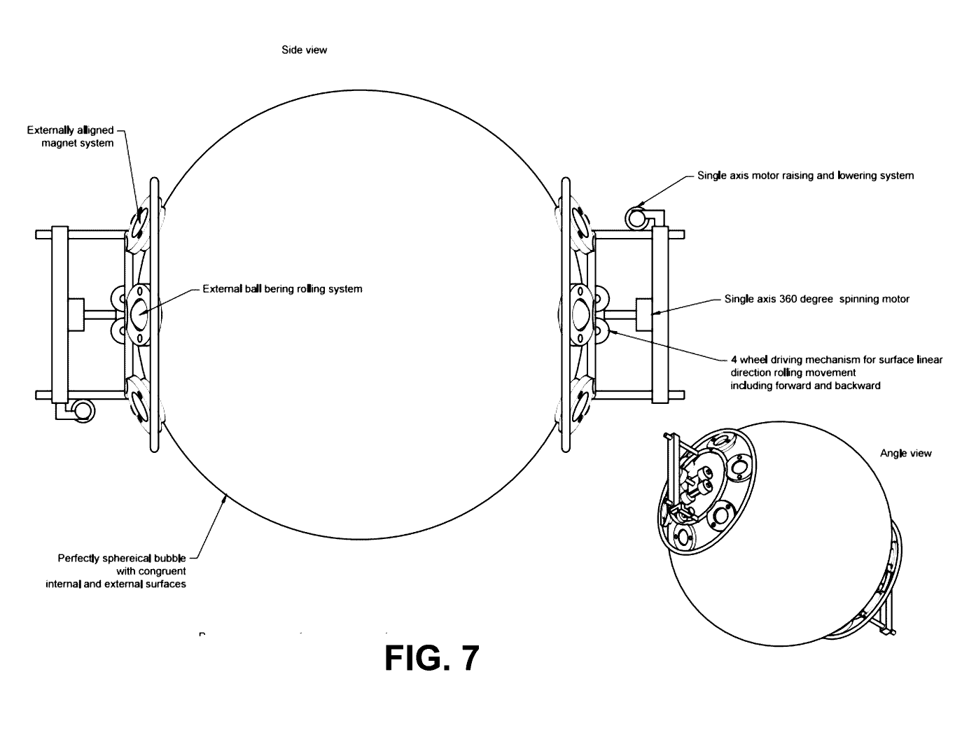

Additionally, in some embodiments, the exploration device 100 of may include a protector enclosing the exploration device 100. Further, the protector may be configured to prevent physical contact between external objects and the support structure 106. Furthermore, in some embodiments, the protector may include at least one of a plastic bubble and a micro net. FIG. 7 and FIG. 8 illustrate exemplary exploration device 100 including the protector in the form of a plastic bubble.

Further, in accordance with some embodiments, an exploration device 100 for facilitating exploration of a specimen is provided herein. The exploration device 100 may include an enclosure 102 configured to contain the specimen. Further, the enclosure 102 may be transparent to visible light. Additionally, the exploration device 100 may include a plurality of cameras 104 disposed around the enclosure 102. Further, each camera may be oriented towards the enclosure 102. Furthermore, images captured by the plurality of cameras 104 may be processable by a computer to generate a three dimensional (3D) digital representation of the specimen. Additionally, the exploration device 100 may include a communication interface coupled to the plurality of cameras 104. Further, the communication interface may be configured to communicate data based on images captured by the plurality of cameras 104. Additionally, the exploration device 100 may include a battery configured to provide electrical power to at least one of the plurality of cameras 104 and the communication interface. Further, the exploration device 100 may include a support structure 106 configured to support each of the enclosure 102, the plurality of cameras 104, the communication interface and the battery.

### Exemplary Embodiments

According to some exemplary embodiments, the exploration device 100 may include an inverse camera sphere system comprising of: a set of cameras, the process for combining information coming into a computer from the set of cameras, sensors, and gyroscopes, a process for recreating an environment, a set of attachments, a mobile device retrofit device, a remote control, an empty glass sphere, a gyroscope, a lens geodesic sphere grid and related processes, a set of data ports, a solar panel box, a set of traversal methods and related processes, and waterproofing measures.

Notably, some of these components/processes may be comprised of other subcomponents/sub-processes which will be discussed later in this disclosure.

It is important to note that this disclosure may utilize abbreviations for specifically phrased systems that focus on certain modern signature developments of the present invention.

MHSMCOCMC or MHS for short stands for Miniature Hoberman Sphere Modification Camera Orientation Control Contraption.

FGSMMCESCGC or GSC for short stands for Fuller's Exploration device Modification Microscope Crystal Expandable Separable Camera Grid Contraption.

The exploration device 100 may be shaped like an exploration device, and may be constructed with separable solar panels with light absorbing lenses. Once the entire system of solar panels is separated, the cameras may be able to turn 180 degrees and remove the microscope lenses, revealing a system of outward facing cameras. These cameras may then capture the world that is around the outside of the exploration device 100 while roaming the environment.

Each camera may include a bright white LEDs configured for providing background illumination. For instance, the light may configured for illuminating mediums in front of the camera opposite to the cameras and the LEDs. Further, in some instances, the LEDs may also provide illumination to the surrounding of the exploration device 100, when the cameras are facing outwards.

Additionally, the cameras may include cycle-able microscope lenses and gyroscopes which are all able to turn 180 degrees, so that they may point outward away from the outer hull of the exploration device while it is expanded, then rotate 180 degrees again and return back when the exploration device has closed.

For instance, according to one embodiment, there may be approximately 50 cameras per hemisphere of the exploration device, making for 100 cameras per exploration device.

Further, the cameras, lenses, and gyroscope contraption(s) are all positioned in the shape of a separable exploration device made of cameras pointing to the center of the GSC. Each camera has a stack of different power lenses. Further, each camera may be able to switch between lenses by choice of user, all happening within as quick as 1/1000 of a second. All cameras may point inward at a center point inside of the Exploration device, and to the center of the inside area of the group of cameras.

Further, in some instances, with the use of multiple exploration devices, with different recharge schedules, the user can use the multiple exploration devices as an effective security system.

The GSC allows for computer programs to recognize precise timing and reaction measurements. For instance, this may include factors such as viscosity and directional movement in a specimen, both surrounding the organisms in the specimen, and inside their organelles. It also allows for 360 degrees spinning and focusing capabilities of the camera in all directions.

In some embodiments, the exploration device may include a box made of solar panels, for easy outdoor and outer-space use and battery recharge. Further, the exploration device may also include a USB charging port.

Further, in some instances, the exploration device could be used for Europa Mission for Ocean exploration, or any space mission requiring Micro Analysis. The exploration device may be designed to work, in an outer-space no-gravity environment. Notably, the exploration device may be water-proof to very-low depths, making it perfect for real-time oceanography.

The exploration device may come with tiny sphere shaped capsules, which may be composed of glass or ultra-high quality clear resin in some embodiments. The capsules may be used for sampling, and the user may fill the capsules with microscopic matter be it aqueous, biological, gaseous, or mineral.

Further, the MHS may be used to control the directional movement of all of the cameras at once. While the MHS is expanded, the mechanisms that contain the lenses and cameras are fastened to the MHS, and then the cameras may be able to switch between different power lenses automatically all at once using a mechanical selection system while the MHS is still expanded. Then the MHS shrinks back down once the lens power has been selected for camera(s) use.

Each camera that is attached to the MHS may also be on a “Joystick” type ball and socket type joint for extremely fine tune focusing, as well as with gears attached to the “Joystick” for mechanical control.

The MHS may reach full expansion, but may not reach full implosion, in order to allow the fastened cameras enough room for micro-mechanical maneuvers while expanded and imploded, and to fit snugly inside of the threshold of the exploration device.

The MHS may include motor and gear devices that are fastened to the inner threshold of the exploration device, as well as fastened to the MHS vertices, allowing for mechanical control of camera positioning for all cameras at the same time using the MHS.

Each camera may be coupled with gyroscopes for analyzing data. The cameras and gyroscopes may be connected to computer processors for processing data coming from cameras and gyroscopes.

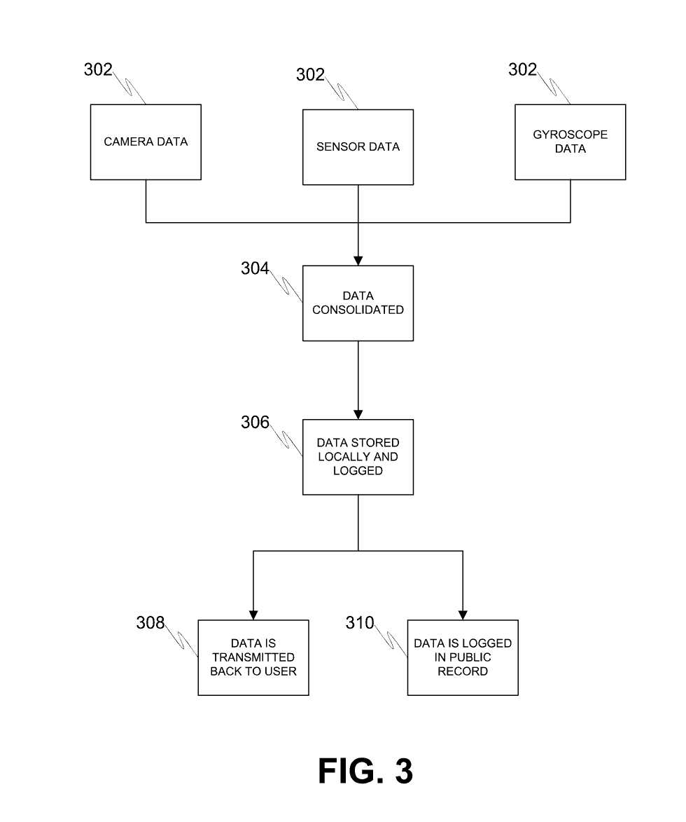

Further, the exploration device may operate by combining information coming into a computer from the cameras, sensors and gyroscopes. As exemplarily illustrated in FIG. 3. Accordingly, at step 302, data from each of cameras, sensors and gyroscopes may be received. Further, at step 302, the received data may be consolidated. Thereafter, at step 306, the consolidated data may be stored locally and logged. Subsequently, at step 308, the consolidated data may be transmitted to a user. Further, at step 310, the consolidated data may be logged in public records.

The processes associated with steps of FIG. 3 are mainly software based but also include hardware, and follow conventional industry-standard algorithms to extrapolate positioning data and other information depending on the types of sensors installed. The software and hardware may combine the information and store it into a memory system inside the exploration device.

Notably, there may be a subsystem including a monitored public record of all past locations, current locations, and destinations of all exploration devices, including all new graphics, and new programs designed for the exploration devices and systems used for maintaining the exploration devices. There is also a subsystem for transmission of information between user and the exploration device. Transmission systems may be similar in implementation to the server-client systems used for MMO video games.

Further, also disclosed herein is the process for recreating an environment such as a specimen contained within the exploration device. Accordingly, the collected data may be used to render via computer a completely digital, visually traversable, three-dimensional XYZ Axis environment, digitally representing the specimen (microsphere). The exploration device may use images and measurements to develop a 3D digital re-creation of the events happening inside the enclosure. Further, in some embodiments, the rendering of the 3D digital representation may be performed at 4K resolution per eye.

Additionally, a VR Interface may be provided which can be manipulated according to time frame type industry standard controls, such as fast-forward, rewind, pause, etc. for analysis.

The ability to traverse in all directions through the recorded space, and back and forth through the time recorded makes the data an accessible and intuitively-usable medium. The viewer is thus able to not only see the specimen(s) from a Point of View angle, but the user is now in an actual 3D traversable digital micro-atmosphere in the shape of a digital plotted sphere.

Notably, this versatility provides for a VR experience beneficial to disabled individuals, allowing them to travel to remote environments they would otherwise be unable to go to.

Further, the exploration device may also be provided with a set of attachments capable of obtaining Ultra-High Quality Monoscopic, Stereoscopic, and 2D Environments, Videos, Images, and Gyroscope information, etc. The software program contained in the exploration device may have subroutines capable of automatically rendering highly detailed 3D Stereoscopic animations. These are precise depictions of what is happening in front of the cameras. The real time digital 3D traversable environment may also be able to utilize the aforementioned data from the Ultra-High Quality Monoscopic, Stereoscopic, and 2D Environments, Videos, Images, and Gyroscope information, all in combination to create the aforementioned traversable 3D experience.

Further, in some instances, a retrofit dock may be provided. This may allow the user to attach a mobile device to the retrofit dock, and control the exploration device via a mobile application. This may utilize industry-standard tools to interface with the exploration device.

Further, in some instances, a remote control device may be provided for controlling the exploration device. The remote control device may be a standalone device, or in alternative and future embodiments, the remote control may be used in conjunction with the retrofit dock. Accordingly, in some instances, the exploration device may be controlled from either the remote control device or the mobile device.

Notably, in some instances, the remote control device may have a touchscreen interface. With this, the user can control the orientation of the exploration device during traveling, crawling, climbing, flying, or self-propelling while submerged, etc.

In addition, the touchscreen interface may have a sub-process display function. This display function may allow the user to view what is occurring inside the exploration device during operation, such as the internal camera workings, their alignment, the fill level of the interior, etc.

Further, in order to contain the specimen, the exploration device may include an empty glass sphere. While the exploration device is submerged in an aqueous substance, notably, the medium such as water or liquid must be able to flow through the viewing area of the cameras. Accordingly, the exploration device may include aqueduct flow system with opening and closing entrances for the flow of medium. This may allow the exploration device to bring in a new surrounding medium into the enclosure, or to flush out the contained medium from the enclosure.

In other words, the exploration device may be equipped with a specially shaped transparent spherical aqua-duct, with entrances and exits for aqueous mediums, with included flow system, allowing entering and exiting and capturing movements to be used to examine mediums, and then move or remove the medium/organisms to and from different areas.

The spherical aqua-duct also acts as a pre-fitted cradle for the included fillable spheres/enclosures. Further, the use of the spherical aqueduct chamber may also act as a pre-shaped capsule containing the medium of choice. Moreover, the spherical aqueduct chamber may also act as a proofing layer, preventing any type of substance into the inner area of sensitive components inside the interior of the exploration device.

Further, in some instances, the exploration device may include a number of layers. There may be an outer layer of Geodesic Solar panel Sphere attached to the second layer. Next, there may be a geodesic grid for attachment purposes, which may be a solid skeleton framework. This may be fixed to: a geodesic grid of gears and mechanisms including copter, floatation, batteries, and computer components. These may be attached to the Hoberman sphere fixed to a “Joystick” type fine tuning gears and mechanics layer. Further, this may be attached to a spherical aqua-duct that can also act as a cradle for a fillable spherical capsule for microscopic mediums, which may contain the user's choice of microscopic medium.

Further, the exploration device may include a gyroscope. This may be an industry-standard internal gyroscope used for determining orientation and balance, and used in an industry-standard manner for determining such factors.

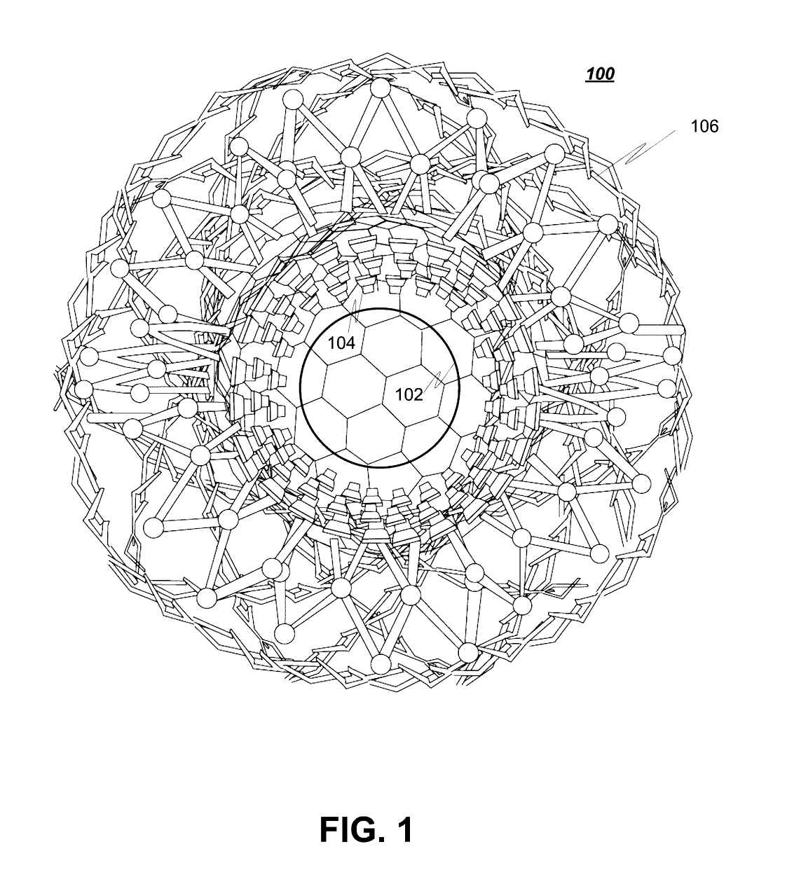

Further, the exploration device may also include the lens geodesic sphere grid. The lens geodesic sphere may be connected to a Hoberman's sphere, which makes it connectable and separable as exemplarily illustrated in FIG. 1. Alternative or future embodiments may have different spherical arrangements, such as a Fuller's Geodesic Sphere, etc. Notably, the spherical arrangement may also be completely spherical in other embodiments, but may not be a subtype of sphere.

Notably, the exploration device may be compact. For instance, the exploration device may be approximately 4 to 6 inches in diameter when fully expanded, with varying encasements. Some extendable sub-devices, like the aerial propeller systems and the solar energy absorbent gliding system, may add to the width of the exploration device while extended.

Further, there may be multiple distinct processes pertaining to the arrangement of the geodesic sphere, described as follows.

There may be a grid-based equilaterally “Separable” Geodesic Sphere, comprised of smaller components. Each piece may be capable of moving outward and inward from a center point for the function of performing microscopy. Each piece of the Geodesic sphere may be floating in empty space, not connected to anything, for the sake of performing the function of separation and return orientation without obstacle obstruction.

The function of the Separable Geodesic Sphere, being separable, each piece may be centered directly on the vertices of vertical expansion and implosion from a center point. This Separable Geodesic Sphere may then brought into motion by being connected to the inside, or outside of the Hoberman sphere.

Further, the exploration device may include multiple layers of Hoberman spheres interconnected for the function of creating an expandable and shrinkable sphere shaped web to which things can be attached for the function of performing precise microscopic measurements and for the use of performing microscopy.

Additionally, in some instances, optional voice recognition process and other features for disabled users may be provided. There can possibly be embodiments specifically designed for handicapped or disabled individuals. In these embodiments, there may be accompanying voice-recognition software and hardware processes.

Voice controls in these embodiments may include, but are not limited to:

“Turn on” for turn on;

“Rise” for upward movement;

“Lower” for downward movement.

Using variable feet or inches dictations include commands such as:

“Rise 100 feet”

“Lower 100 feet 1 inch”

“Land” for landing movements,

“Left” left for rotating the view left 5 degrees

“Right” right for rotating the view right 5 degrees

“Down” for tilting the view down 5 degrees

“Up” for tilting the view up 5 degrees

“Return” for return to user.

“Extend” “option” for the use of extendable armatures

Notably, there may be other forms of user interfaces designed for disabled or handicapped individuals. Such interfaces include but are not limited to: eye movement sensors for automatic remote directional controls, including blink code recognition for remote control perimeters, and head orientation recognition for automatic directional controls.

Notably, such controls may require user authentication, possibly biometric identification. This may include but is not limited to: fingerprint, voice recognition, retinal scan, etc.

Further, the exploration device may be provided with a set of data ports. For instance, this may include wireless and data ports, including but not limited to: USB, mini-USB, HDMI, etc. An internal computer may then receive data from the exploration device via wireless connection or wired connection.

Further, the exploration device may include a solar panel box. Notably, there may be an aim-able solar panel shell layer. Accordingly, each panel may be aimed in the direction most efficient for absorbing sunlight, connected to robotic propulsion and traversal systems. This forms the outer shell of the geodesic sphere. The outer shell may be a separable geodesic sphere, and the internal camera system may also be a geodesic sphere, one nested inside the other.

This ability to encapsulate the exploration device with a system of solar panels and sun-gathering lenses, is for the sake of self-sustaining power, by the use of rechargeable batteries making energy, or a direct transmission of solar energy being absorbed at that moment is then used to power the devices computer and mechanical components that can be used for streamline function in outer space, in combination with cameras with the ability to turn 180 degrees, remove their microscope lenses, then begin recording in a “Regular camera” mode of outer-atmospheric 3D while the device is expanded, in combination with the ability to be dropped to great depths in any planetary ocean.

Further, in some instances, the exploration device may include a set of traversal mechanisms. For example, this may include ground traversal method, air traversal method and aquatic traversal method. In additional, navigation features may also be provided.

Further, in some instances, the exploration device may have no home base. Accordingly, the exploration device may self-propel along the ground and traverse any traversable space, including air, and climbable surfaces accessible to four attached arms included in the exploration device.

Also, the onboard software in the exploration device may be capable of performing physics calculations based on measurements of the surrounding area for developing physical maneuvers involving the most efficient and effective route and process of travel. All physical movements may also manually controllable.

In the ground traversal method, the exploration device can roll in any direction as controlled by the user. The control may be via remote control, voice activation, gesture, etc.

Further, in some instances, there may be mechanisms under each solar panel to flick the solar panel to orient movement for the exploration device. Each solar panel may act almost like a foot. Since each solar panel has a hard clear transparent coating, this adds resilience and lets it be durable enough to handle the stress of traversing the ground. Each mechanism may be linked to the skeleton or the support structure, to help propel the exploration device along the ground. Thus, the exploration device can roll on its own, in any direction as controlled by the user.

In terms of ground traversal, the exploration device may also be capable of traversing sheer surfaces such as cliffs. Accordingly, the exploration device may include a plurality of arms, such as for example, four. The plurality of arms may be based around a geodesic skeleton, in one of the middle layers of the exploration device. The plurality of arms may include climbing claws which can climb scalable surfaces like cliff faces. Each arm can grip tree branches and similar objects, allowing the exploration device to navigate irregular outcroppings and objects. The plurality of arms may be connected to different quadrants of the exploration device and may be able to slide along the curved vertical axis of a respective quadrant. Further, there may be pre-programmed or programmed methods for climbing different trees and different terrain, while functioning with manual user control. This may include suitable branch recognition and automatic branch take-off/launch point software. This may also include tactile terrain gripping systems, like interchangeable small retractable claws and rubber feet for maneuvering and climbing.

In the air traversal method, the exploration device may include a plurality of propellers. In some embodiments, the number of propellers may be four. Other embodiments may include, but are not limited to: a retractable 6 propeller hexa-copter model, 4 propeller quad-copter model, 3 propeller tri-copter model, etc.

Further, the air traversal method may be facilitated by a geodesic sphere micro net for surrounding the exploration device while airborne, to prevent undesired interactions with birds and other aerial creatures. Alternatively, a protective bubble may be provided around the exploration device. Notably, there may be a retractable gliding emergency landing system, in case of instances like engine failure.

Some embodiments may include a type of Gliding Mechanism that is extremely light and compact and foldable, comprised of a type of solar energy absorbing fabric for quicker refueling of the battery system used for aerial propulsion. Thus, the aerial traversal may continue indefinitely so long as the battery is not depleted.

In the aquatic traversal method, the exploration device may act as a submersible. In this case, the propellers in the air traversal method may be re-oriented and re-positioned via new configurations so the propellers can be used as nautical screws.

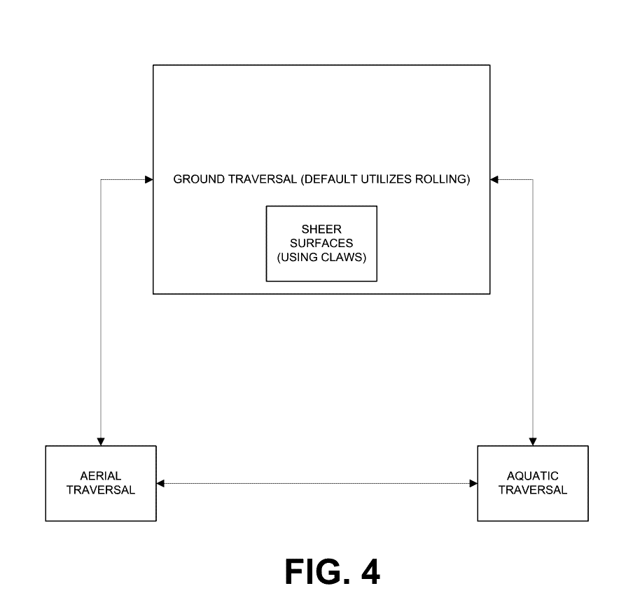

Notably, the traversal systems may transition from one to the other as exemplarily illustrated in FIG. 4. For example, the exploration device can then take off from the top of a tree or cliff, and retract its climbing arms simultaneously.

Notably, the traversal methods may include navigation features such as, but not limited to: radio, sonar and night vision for non-visible environments. Alternative or future embodiments of the exploration device may include star map orientation recognition, solar, lunar, and planetary orientation recognition.

Notably, during traversal, the exploration device may include a subsystem of recharging and mechanical maintenance stations across the globe. These stations may allow the exploration device to be sustained. Such stations may include the ability to perform full diagnostics and install parts and charge energy as needed. This is depicted in FIG. 2. Housing space may be provided for different exploration devices, including rentable space to land or park user-owned exploration devices.

Further, the exploration device may be provided with a set of waterproofing measures. These may be industry-standard waterproofing measures such as silicone coatings and epoxy coatings for the circuitry. Alternative or future embodiments of the exploration device may use other industry-standard waterproofing methods.

Accordingly to some embodiments, a spherical device for performing microscopy may be provided. The inside of the spherical device may include an inwardly focused system of cameras, each having a designated orientation and focusing origin based on the center point of the spherical device that extends to the edge of visibility that each camera is capable of acquiring. Accordingly, the spherical device may be configured to obtain “The Surrounding Light Complex”: an extremely dense network of line of sight based perspectives, as exemplarily illustrated in FIG. 8, that can be used in creating a digital tomographic structure that uses photogrammetric light configuration systems to develop a holographic atmosphere capable of being examined and traversed in all directions inside of a Spherical device, (or Marble), of Digital Light Information, allowing the user to capture, create, develop and experience a vastness of an atmospheric area of variously sized living and non-living environments. The information is then computed and the user is able to experience the chosen area through computer application or virtual reality interface. Also with the use of virtual reality the user is able to develop a collection of marbles filled with the information of the chosen objects, as well as hold the objects in their hands, as well as walk amongst areas previously out of the range of traversing on the plane of human sized experience. The proposed spherical device also attains the ability to experience a larger area of optically available micro sized areas and creatures and objects due to the surrounding nature of the camera system, one can see more of any proposed area. The proposed spherical device is set to study areas and objects above the molecular state as not to impose upon the work of CERN with the Large Hadron Collider, and is set to study a system that is less than a planet as not to impose upon satellite type information collection systems including Google earth. The method of capture is specially designed for capturing the movements of living and non-living objects and the area around them, for the sake of study or entertainment.

Further, the spherical device is designed to specifically capture entire objects, creatures, and spatial areas. Each camera is capable of moving as needed to collect all of the light information that is encapsulated inside the network of cameras. The mechanics that attach to the cameras, allows them to move and to perform the needed functions for collecting enough visual light information to develop a digitally traversable Mable that represents the medium/specimen/atmosphere (s) that are dwelling in the center of the spherical device. The system of mechanics enables the system of cameras to be controlled as one entity. Also each camera is attached to a type of Joy stick movement control system, as well as a singularly assigned extension/retraction system for each camera, for necessary fine tune movements.

One special function of the system proposes that each camera is capable of performing as a light field type camera, (patented by Lytro) and does not necessarily be capable of single plane or depth of field zoom focusing, as the Lytro system is capable of capturing the entire z axis line of site, as well as some of the x and y axis, as a set of images without need for an extensive system of focus functions, which is very important for making this device as quick and efficient as possible in terms of processing and capturing information.

As well, each camera itself in its entirety, or the entire entity of cameras used in the system, is capable of moving closer or further in accordance to the origin of the spherical device. Each camera is not on a fixed stability system, but is on a mechanical system that allows the entire camera or entity of cameras to move by means of a structural system that relates synchronously to the structural mechanics of the Hoberman spherical device.

The medium/specimen/atmosphere (s) may or may not be in a transparent capsule that is at the center of the device. One embodiment includes a series of specific systems that orient a transparent capsule specially designed to encapsulate a users object(s) of study, and for keeping the object(s) of study at the center of the proposed system of cameras, so that the system of cameras may attain the proper perspectives for being able to capture every visible angle of the object(s) of study with the least amount of image capture distortion or interference from the movement of the surrounding bodies of cameras and moving mechanisms.

The system of inwardly oriented cameras are attached to a specially designed motion system that allows each camera to move synchronously with the entire system of cameras thereby making the entire system of cameras and their mechanical movement systems as a single moving entity while leaving the medium/specimen/atmosphere (s) in a peaceful non-disturbed state, allowing for excellent representation of the medium/specimen(s) via digital photogrammetry to develop a spherical holographic atmosphere that can be studied and Traversed by use of Virtual Reality interface and/or a computer system.

One object for of the spherical device is the ability to capture a specific amount/shape of an area, this amount/shape is represented by an empty sphere that is filled with information by a collection of cameras that are each capable of capturing a range of perspectives ranging from Micro to a large area perspective. Anything or shape that can fit inside of this device can inherently be studied.

Further, the spherical device includes cameras and movement controls that also face outward from the entire encapsulated system in order for the user to determine and control orientation and movement during atmospheric travel, i.e. while it is submerged or floating in a body of liquid, or rolling along a surface.

Further, the spherical device may include solar panel feet, each attached to a pushing/extending object used for manual movement/orientation as well as sunlight energy absorption, referred to as a “Solar Foot”. The solar foot system is detachable, for use in areas where a user has direct access to electricity. The Solar Foot system is a shell attached to a collection of self assembling robots, each including magnets for direct connection to each other, as well as cables for physical and electrical connection and stability while being attached to the main shell that attaches to the outer hull of the spherical device.

The various embodiments of this camera system are based on the type of light being collected. Different types of light include Natural Sun based light, LED type light systems, and Laser light systems. Accordingly, different camera and component configurations for each type of light capturing system may be provided.

In some embodiments, lens sphere encasement for transparent capsule may be provided. Accordingly, a sphere entirely made of conjoined lenses capable of separating along an equator to allow the placement of an object inside may be provided.

Further, in some embodiments, a floating quick spin magnet orientation system for center capsule may be provided. Accordingly, an empty sphere may be provided with a system of specially fastened and oriented magnets along the outer or inner surface of the sphere, to allow another smaller or larger sphere with an expanded orientation of magnets to be placed at the center or around the outer surface of the first sphere using the center point origin of the dual sphere system to allow the internal sphere the ability to float directly at the center of the outer sphere, while leaving the available space inside of the internal area of the inner sphere viewable on the basis that a viewer can see in-between the latitude and longitudinal areas between the magnets, allowing a fully surrounding camera system to move about without disturbing the inner contents of the inner area of the inner sphere, thereby relieving the need for a directly connected base system for the internal structure and allowing for full spectrum movement in any latitude or longitudinal direction.

Further, in some embodiments, the spherical device may be able to move the entire entity of internal cameras at once as one object, and as well to gain and enhance the surrounding perspective of an object or space by moving the entire entity of internal cameras at once. With this in mind, it is important to realize how a spherical entity of camera systems can utilize such movement, and what actions should be taken to effectively enhance such a system. The following are two systems of utilizing movement of the entire system for enhancing the spherical perspective inside the system of cameras and for creating an effective use of spherical movement.

The first and simplest form of a movement system is: a manual or computer controlled repetitive dual circle drawing hemispherical wobble, which consists of the previously proposed system of cameras and mechanics connected to an outer singular structure or base that has opposing ends that reside on completely opposite sides of the camera entity. Each end is then connected to a motor-servo ball joint system, that when both opposing servo ball joint systems are moving in a polar circling motion, having the ball joint slightly off center of the polar point, and having the ball joint in an orientation on opposite sides of the circumference of the circle path encircling each pole, causes each camera to effectively draw a circle around its corresponding point of origin, thereby expanding the field of perspectives capable of being viewed and analyzed and collected.

The second more complex and more functionally enabling system is as follows: Dual Fine tune Latitudinal and longitudinal movement system for controlling entire internal mechanical entity. Including manual hand controlled version.

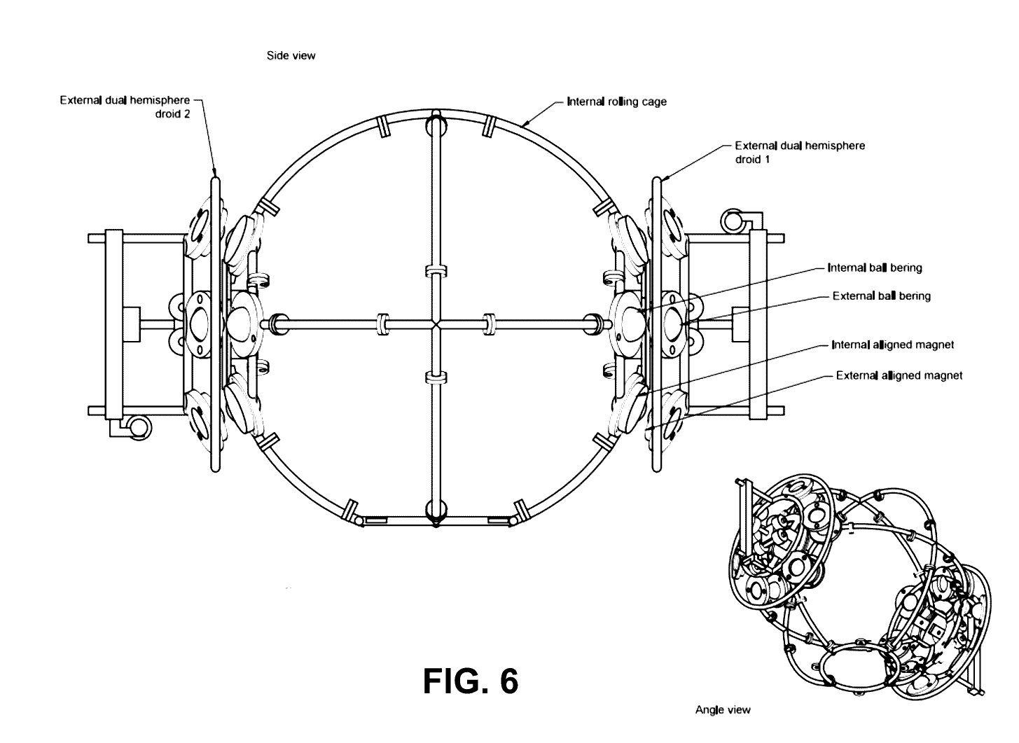

As illustrated in FIG. 5 and FIG. 6, an outer shell wireless droid magnet system may be provided for control of movement of entire internal entity of cameras and attached mechanisms, capable of 360 degree movements based on the surface area of a global graph of paths including unlimited angular latitude and longitude control of movement in any direction over the entire surface of the globe shape.

Two droids, each on a constant orientation based on completely opposite sides of the outer surface of the spherical device, each having congruent magnets that are attached underneath the droid, and having another (second) set of congruent magnets directly inside of the main outer bubble of the proposed spherical device, so that when the outer droids move around the surface of the containment bubble, they automatically control the entire entity of mechanisms residing inside of the containment bubble, as illustrated in FIG. 7.

Each Droid is based on a rotating joint, that when locked allows spinning of the internal entity, and when not locked allows for pre-orientation of the movement system. The rotating joint then has an arm that is extended laterally from the center of the rotating joint, at the end of the arm is a Y joint that extends two arms slightly beyond the Y joint, at the end of each arm is a mechanism of motors and wheels. Each arm has a set of wheels that point in either a latitude direction, or a longitude direction, and each set of wheels is fixed to a mechanism that allows the wheels to rest on the surface of the containment bubble for directional movement or be raised to a status where there is no connection to the surface to allow the other arms set of wheels to control the direction of movement, and vice versa.

Although the invention has been explained in relation to its preferred embodiment, it is to be understood that many other possible modifications and variations can be made without departing from the spirit and scope of the invention. Obvious changes, modifications, and substitutions may be made by those skilled in the art to achieve the same purpose the invention. The exemplary embodiments are merely examples and are not intended to limit the scope of the invention. It is intended that the present invention cover all other embodiments that are within the scope of the descriptions and their equivalents.

The following is claimed:

1. An exploration device for facilitating exploration of a spatial region comprising at least one object, the exploration device comprising:
a. an enclosure configured to contain a specimen, wherein the enclosure is transparent to visible light;
b. a plurality of cameras disposed around the enclosure, wherein each camera is orientable towards the enclosure, wherein images captured by the plurality of cameras are processable by a computer to generate a three dimensional (3D) digital representation of the spatial region, wherein the spatial region comprises the specimen when the plurality of cameras is oriented towards the enclosure;
c. a communication interface coupled to the plurality of cameras, wherein the communication interface is configured to communicate data based on images captured by the plurality of cameras;
d. a battery configured to provide electrical power to at least one of the plurality of cameras and the communication interface; and
e. a support structure configured to support each of the enclosure, the plurality of cameras, the communication interface and the battery.

2. The exploration device of claim 1, wherein each camera of the plurality of cameras comprises at least one microscope lens.

3. The exploration device of claim 2, wherein each camera of the plurality of cameras comprises a plurality of microscope lenses corresponding to a plurality of optical magnification, wherein each camera further comprises a lens actuator configured to select a microscope lens of the plurality of microscope lenses, wherein selection of the microscope lens results in capturing images at an optical magnification of the microscope lens.

4. The exploration device of claim 1 further comprising at least one light source configured to illuminate the specimen, wherein the support structure is further configured to support the light source, wherein the battery is further configured to provide electrical power to the light source.

5. The exploration device of claim 1 further comprising a plurality of actuators corresponding to the plurality of cameras, wherein an actuator corresponding to a camera is configured to change at least one of an orientation, a position and a focal region of the camera, wherein the support structure is further configured to support the plurality of actuators.

6. The exploration device of claim 1, wherein the support structure is configured to be expandable and collapsible.

7. The exploration device of claim 1, wherein the support structure is based on at least one of a Hoberman's sphere and a Fuller's Geodesic Sphere.

8. The exploration device of claim 5 further comprising a plurality of ball-and-socket joints coupled to the plurality of cameras, wherein a ball-and-socket joint coupled to a camera is configured to maintain the camera in one of a plurality of orientations, wherein an actuator corresponding to the camera is coupled to the ball-and-socket joint, wherein the support structure is further configured to support the plurality of ball-and-socket-joints.

9. The exploration device of claim 1 further comprising at least one duct fluidly connected to the enclosure, wherein the at least one duct comprises at least one opening to receive fluid and at least one opening to expel fluid.

10. The exploration device of claim 1 further comprising a plurality of gyroscopes coupled to the plurality of cameras.

11. The exploration device of claim further comprising at least one sensor coupled to each of the plurality of cameras, wherein the communication interface is further configured to communicate sensor data generated by the at least one sensor.

12. The exploration device of claim 1 further comprising a plurality of solar panels separably disposed over the support structure, wherein a solar panel is configured to charge the battery based on light energy received on the solar panel.

13. The exploration device of claim 5, wherein the plurality of actuators are configured to orient the plurality of cameras towards a surrounding of the exploration device, wherein the surrounding comprises the spatial region.

14. The exploration device of claim 13, wherein the plurality of cameras comprises a first set of cameras oriented towards the enclosure and a second set of cameras oriented towards the surrounding.

15. The exploration device of claim 1 further comprising at least one propulsion system connected to the support structure, wherein the at least one propulsion system is configured to propel the exploration device in at least one of land, water, air and outer space.

16. The exploration device of claim 5 configured to be remotely controlled, wherein the communication interface is configured to wirelessly receive a control signal from a remote control device, wherein the actuator is configured to change at least one of an orientation, a position and a focal region of the camera based on the control signal.

17. The exploration device of claim 16 configured to be remotely controlled by a mobile phone connected to a retrofit dock.

18. The exploration device of claim 15 configured to be remotely controlled, wherein the communication interface is configured to wirelessly receive a control signal from a remote control device, wherein operation of the at least one propulsion system is based on the control signal.

19. The exploration device of claim 15, wherein the at least one propulsion system comprises a plurality of arms configured to enable the exploration device to climb a vertical surface.

20. The exploration device of claim 1, wherein the support structure comprises a plurality of spherical structures concentric to each other, wherein each spherical structure is configured to be expandable and collapsible.

21. The exploration device of claim 1 configured to float on water.

22. The exploration device of claim 1 configured to be water resistant.

23. The exploration device of claim 1 further comprising a protector enclosing the exploration device, wherein the protector is configured to prevent physical contact between external objects and the support structure.

24. The exploration device of claim 23, wherein the protector comprises at least one of a plastic bubble and a micro net.

25. The exploration device of claim 19, wherein an arm of the plurality of the arms is further configured to direct an object towards an opening of at least one duct comprised in the exploration device, wherein the at least one duct is fluidly connected to the enclosure.

26. The exploration device of claim 1, wherein the plurality of cameras are associated with a plurality of line of sights, wherein images captured by the plurality of cameras according to the plurality of line of sights are processable based on digital tomographic reconstruction in order to generate the 3D digital representation.

27. An exploration device for facilitating exploration of a specimen, the exploration device comprising:
a. an enclosure configured to contain the specimen, wherein the enclosure is transparent to visible light;
b. a plurality of cameras disposed around the enclosure, wherein each camera is oriented towards the enclosure, wherein images captured by the plurality of cameras are processable by a computer to generate a three dimensional (3D) digital representation of the specimen;
c. a communication interface coupled to the plurality of cameras, wherein the communication interface is configured to communicate data based on images captured by the plurality of cameras;
d. a battery configured to provide electrical power to at least one of the plurality of cameras and the communication interface; and
e. a support structure configured to support each of the enclosure, the plurality of cameras, the communication interface and the battery.
